(19) United States
(12) Patent Application Publication
(10) Pub. No.: US 2006/0253572 A1
(43) Pub. Date: Nov. 9, 2006

(54) Method and system for management of an electronic mentoring program

(76) Inventors: Osmani Gomez, Ottawa (CA); Patrick Lajeunesse, Ottawa (CA)

Correspondence Address: PILLSBURY WINTHROP SHAW PITTMAN, LLP, P.O. BOX 10500, MCLEAN, VA, 22102, US

(21) Appl. No.: 11/402,830

(22) Filed: Apr. 13, 2006

Related U.S. Application Data
(60) Provisional application No. 60/671,125, filed on Apr. 13, 2005.

(51) Int. Cl. G06F 15/173

(52) U.S. Cl. 709/224

(57) ABSTRACT

The invention comprises a platform that allows the complete development and management of an online mentoring program. This includes: a hierarchical administration system a user management with custom data fields stored for each user type a project-based mentor and student participation component tools to track program participation. The system stores and manages the hierarchical structure in a relational database management system. One of the unique aspects of this design allows a complete separation of programs by client, and allows hierarchies of any size with no appreciable degradation in performance of the system.

### REFERENCE TO RELATED APPLICATIONS

This application claims the benefit of U.S. Provisional Patent Application No. 60/671,125, filed Apr. 13, 2005, which is hereby incorporated herein by reference in its entirety.

### BACKGROUND OF THE INVENTION

Mentoring programs have been proven to be effective in improving the educational attainment of children. Traditional mentoring programs are limited because of the need for face-to-face communications. An online mentoring program provides all of the benefits of the traditional mentoring program, but with an implementation that greatly simplifies both participation and management.

### DESCRIPTION OF A PREFERRED EMBODIMENT OF THE INVENTION

Hierarchical Administration

The eMentoring Platform uses a hierarchical administrative structure, which is based on the “location” of users. The location usually refers to a physical location. For example, a typical location hierarchical path might be:

North America>United States>West Virginia>Richmond Public Schools>Woodrow Wilson Elementary School>Mrs. Brown's Classroom

The platform allows an administrator to create their own custom hierarchy for the use of their program. Each location has a “parent,” and can have any number of “siblings” and “children,” as is typical in a tree-structure. A unique component of the invention is the way the hierarchy is managed in a relational database to optimize the speed of lookups.

In a typical tree, each node's parents are stored along with that node. Each node is aware only of its parents, but not its children. To descend the hierarchy, it's necessary to query for all nodes whose parent is the starting node. The desired child node is chosen, after which another query must be conducted to identify the nodes with the now-current node as their parent, and the process continues until the desired node is reached. This system is functional, but in practice is too slow to use in an application that users are interacting with in real-time. In addition, performance will decrease exponential the higher in the hierarchy the query is run.

To obviate this problem, a unique solution was reached. In addition to storing the parent of each node, every ancestor for each node is stored. This allows an immediate selection of each node that's below a particular node, through a single query. In practice, it is this invention that allows the platform to work efficiently.

Mentor Program Administration

Working with the Hierarchy

A typical hierarchy might look like:

Global>United States>West Virginia>Richmond Public Schools>Woodrow Wilson Elementary School>Mrs. Brown's Classroom

Administrators may add new nodes to the hierarchy at any point. When creating a location, administrators are required to enter a location name and choose a location type. The location type is used to help organize the locations and the accounts that are created within it. There are five possible choices for location type:
Country
State/Province
District
City
School

If the location does not fit into one of these categories, it can be marked as “Other.” Every new node created will be added at the same level as the other nodes visible in the table. For example, to add a new school to a list of existing schools, you would first navigate to the “City” or “District” location (or whatever logical location holds all of the schools in that area).

The structure is completely flexible and can be adjusted at anytime. The only limitation is that a particular administrator can only affect the structure at or below their current location. This means that a teacher who was created at the “Woodrow Wilson School” location in the example above would not be able to create a category for a district above that school. That task would have to be performed by an administrator higher in the hierarchy. This structure allows for a complete separation of one program from another, and allows administrators to have access to data and to focus on only those areas that are relevant to them.

User Roles

The three main account types are administrators, students, and mentors.

Administrators: Administrators have complete management control over their location in the hierarchy and below (their “purview”), Their interface allows them to create users and edit their attributes, create new locations, match mentors to students, assign mentor/student pairs to projects, and track participation.

Students: Students only have the ability to communicate online to their mentor.

Mentors: Mentors have the ability to communicate online with their student(s) and to change their own account information.

Users can be self-registered through a controlled-access form, or can be created by an administrator. Each user is added at a particular location in the hierarchy. In the case of mentors and students, the user's location dictates which administrators will have access to the user for matching.

Users can be viewed by any administrator who has that user in their purview.

Matching Mentors and Students

As in most eMentoring administration functions, the actions take will be dependent on the location where you're located when performing the action. Users can use a pull-down menu at the top of each screen to navigate to the desired location to begin matching. The chosen location will be maintained throughout the session.

Administrators have access to match any students in their “purview” (that is, at or below their current location). They have access to any mentors both in their location's antecedents and in their purview. This allows a mentor to be created at a high level, so they can be available to a wide variety of administrators. For example, a mentor could be located at the “United States” level, and therefore be available for matches at any location within the United States.

The system allows both automatic and manual matches. In a manual match, the administrator can conduct a search for users matching any criteria stored on the users. Matching users are returned, from where they can be selected and added to a match. In an automatic match, the administrator merely specifies the location to begin the match and the criteria the match should be made on. This allows a simple match of mentors and students who share attributes such as gender and languages spoken.

The match system is completely flexible, and allows multiple students and mentors to be added to a match if desired.

Assigning Users to Projects

When pairs have been made, they can be assigned to projects. All mentor/student interaction is through participation in various projects. These projects are designed to foster communication between the participants, as well as providing directed work on particular curriculum areas if required. Pairs can be assigned to as many projects as desired.

Administrators can create new projects at any time. Like users, projects are created at particular locations. The location of a project determines whether an administrator has access to it for the purpose of assigning users.

Mentor and Student Participation

Mentors and students login to the system using the username and password that had been assigned to them at the time of their account creation. Their interface provides easy access to the projects to which they have been assigned. Actual participation in the projects works very much like a typical online bulletin board system, with the exception being that postings are only visible between a mentor and their student partner. Each user makes postings in turn. On a subsequent login, the partner will view the posting and respond.

Tracking Participation

There are two main components to allow administrator to track user participation. First, they have access to view the postings made by any mentors or students within their “purview.” In addition, they are able to view a summary report that shows which users have or have not posted or logged into the system within a certain time frame. Combined, these two tools allow administrators complete control over the activity within their own program.

What is claimed is:

1. An on-line mentoring system comprising:
a. a hierarchical, location based administrative system accessed by a designated administrator;
b. a student user account created within the administrative system to permit the student user to communicate within the mentoring system in accordance with the communication criteria established by the administrator;
c. a mentor user account created within the administrative system to permit the student user and the mentor user to communicate with each other within the mentoring system;
d. a project based participation system within the mentoring system to permit the mentor user and student user to be assigned projects; and,
e. a participation tracking system within the mentoring system to permit the administrator to determine the mentor/student participation.
